(19) United States
(12) Patent Application Publication
(10) Pub. No.: US 2010/0128753 A1
(43) Pub. Date: May 27, 2010

(54) Multiple-Stage Thermometer and Temperature Monitoring

(75) Inventors: Christopher J. Claypool, Huntersville, NC (US); Mark S. Stultz, Huntersville, NC (US)

Correspondence Address: LEMPIA BRAIDWOOD LLC, One North LaSalle Street, CHICAGO, IL, 60602, US

(73) Assignee: Rubbermaid Incorporated, Huntersville, NC (US)

(21) Appl. No.: 12/323,604

(22) Filed: Nov. 26, 2008

(51) Int. Cl. G01K 1/02; G01K 3/00

(52) U.S. Cl. 374/102; 374/E03.001; 374/E01.002

(57) ABSTRACT

A thermometer to monitor food in accordance with a monitoring procedure includes a measurement input probe to contact the food to capture temperature information, and a housing coupled to the measurement input probe and having a user interface. Visual indicators of the user interface have a modifiable appearance to convey status information for a respective stage of the monitoring procedure. A controller disposed in the housing is configured to implement a routine in accordance with the monitoring procedure and in response to the temperature information. The routine includes a timer routine to count elapsed time, and is configured to cause the controller to direct the display to convey the temperature information and to indicate the elapsed time, and to direct each visual indicator to convey the status information in accordance with the temperature information and the elapsed time.

### BACKGROUND OF THE DISCLOSURE

1. Field of the Disclosure

The present disclosure is generally directed to thermometers and temperature monitoring methods, and more particularly to thermometers and temperature monitoring methods configured for compliance with multiple-stage guidelines for food handling and storage.

2. Description of Related Art

Many thermometers are equipped with timers to monitor food during preparation and other handling. Thermometer timers are often activated by a user. Other timers are triggered based on the temperature measurement. With triggered timers, thermometers are typically used to monitor the amount of time that food is cooked at or above a given temperature.

Guidelines have been promoted for the safe preparation and other handling of food. Some of the guidelines are directed to the safe storage of food after it has been cooked. For example, guidelines have generally specified temperature zones for safely cooling the food down from a cooking temperature. Such “cooldown” guidelines require each temperature zone to be reached within a corresponding time interval. In this way, the food is handled and stored in a manner that avoids excessive time in dangerous temperature ranges where pathogens can thrive.

Cooldown guidelines are set forth for the restaurant and food service industry by the Food and Drug Administration (FDA) in the 2001 Food Code (revised 2004) under “Temperature and Time Control” section 3-501.14 (“Cooling”). Under these guidelines, certain types of cooked food should be cooled from 140 F to 70 F within 2 hours, and from 140 F to 41 F within six hours. The National Restaurant Association Educational Foundation (NRAEF) has promoted these guidelines under its “ServSafe” food safety program. Under NRAEF, food that does not reach the temperature zones as specified in the guidelines must be re-heated to 165 F for 15 seconds, after which the cooldown process can begin again.

The COOLIT-RITE™ TTM-41 thermometer commercially available from Cooper Atkins has a timer to track the temperature of food during a user-defined time period during cooling to 41 F. The TTM-41 thermometer generates an audible alert when the time period expires or the temperature reaches 41 F. If the time period expires, a display interface of the TTM-41 thermometer indicates the temperature when time expired. If the temperature reaches 41 F before expiration of the time period, the timer then counts up from a time of 0:00 (0 hours, 0 minutes).

U.S. Pat. No. 6,811,305 discloses a data logger directed to compliance with food cooling guidelines. The data logger records time and temperature data at two-hour intervals until six hours has elapsed, at which point data logging ceases. The logged temperature and time data may then be obtained via downloading from an output port for further use.

### BRIEF DESCRIPTION OF THE DRAWINGS

Objects, features, and advantages of the present invention will become apparent upon reading the following description in conjunction with the drawing figures, in which:

FIG. 1 is a front, elevational view of an exemplary thermometer constructed in accordance with several aspects of the disclosure.

FIG. 2 is a side, elevational view of the exemplary thermometer of FIG. 1.

FIG. 3 is a perspective view of the exemplary thermometer of FIG. 1 with a container shown in cutaway to depict the thermometer engaging the container in accordance with one aspect of the disclosure.

FIG. 4 is a front, elevational view of a user interface of the exemplary thermometer of FIG. 1.

FIG. 5 is a block diagram of a controller of the exemplary thermometer of FIG. 1 in accordance with one embodiment.

FIG. 6 is a flow diagram of a routine implemented by the controller of FIG. 5 during a startup phase of an exemplary cooldown procedure.

FIG. 7 is a flow diagram of a routine implemented by the controller of FIG. 5 during a first stage of an exemplary cooldown procedure.

FIG. 8 is a flow diagram of a routine implemented by the controller of FIG. 5 during a second stage of an exemplary cooldown procedure.

FIG. 9 is a flow diagram of another routine implemented by the controller of FIG. 5 during the second stage of an exemplary cooldown procedure.

FIG. 10 is a front, elevational view of an exemplary thermometer in accordance with an alternative embodiment.

FIG. 11 is a side, elevational view of the exemplary thermometer of FIG. 10.

FIG. 12 is a perspective view of an exemplary thermometer in accordance with yet another alternative embodiment.

### DETAILED DESCRIPTION OF THE DISCLOSURE

The present disclosure is generally directed to thermometers configured to implement temperature monitoring techniques for compliance with guidelines or standards for food handling and storage that have multiple stages or zones. Several aspects of the disclosed thermometers facilitate compliance with the guidelines or standards by clearly and comprehensively providing information via a user interface. For instance, some aspects of the disclosed thermometers are directed to providing a multiplicity of user interface elements despite the limited space available on the thermometer. In some cases, the user interface elements include respective visual indicators for each stage. In these and other cases, the user interface may include both alphanumeric and non-alphanumeric visual elements that provide redundant presentations of compliance information. The user interface may also be configured to provide visual indications for intermediate status updates before completion of a stage to reflect, for instance, progress toward compliance. These and other visual elements of the user interface may be incorporated in spite of the limited space available on the thermometer.

Generally speaking, each temperature zone or stage is established via the guidelines or standards. While the thermometers are described below in connection with the two stages of the FDA cooldown guidelines, the disclosed thermometers and temperature monitoring techniques are well suited for use in connection with any multiple stage guideline or standard. Indeed, the disclosed thermometers are not limited to use with a specific guideline or standard, and may be used with any staged cooking, cooldown, or other food handling procedure. Thus, the disclosed thermometers can provide a set or series of indications of the extent to which any guidelines, standards, or other desired procedure have been met.

The user interface is arranged to convey and present status information and data in a comprehensive yet space-efficient manner despite a number of challenges presented by the food handling context. The type and level of information and data required by a user or operator may vary considerably throughout the food handling process. At times, the user may need in-depth information or data. At other times, the user may want or need only a quick status check. In accordance with one aspect of the disclosure, the thermometers may include different types of visual user interface elements, including both alphanumeric and non-alphanumeric elements to address the various informational requirements during the course of the cooldown or other process. In some ways, this approach may introduce redundancy into the user interface layout. But these and other aspects of the disclosed thermometers result in interaction with the user interface that involves minimal, if any, user input or direction during the cooldown or other process. In other words, the user interface is configured to present the information and data in an immediate, clear, and intuitive manner that does not force the user to handle the device.

The disclosed thermometers provide these useful user interface features without conflicting with the need to position the device to capture the temperature measurements. In other words, the disclosed thermometers are configured for immediate, comprehensive access to the information and data, despite having a user interface (and overall device) sized in accordance with the food monitoring context. The overall device size and configuration allows the disclosed thermometers to remain in contact with the food to obtain accurate food temperature measurements. Moreover, several aspects of the user interfaces described below allow a user to obtain feedback and other information despite the close proximity of the user interface to the food during the course of the cooldown process. Still further, the disclosed thermometers are also configured to prevent the container in which the food is disposed from blocking a user from obtaining the information during the process. These and other aspects of the disclosure also allow containers to be stored side by side, closely arranged in a limited space, such as a refrigerator. That is, the disclosed thermometers are designed to fit within a limited amount of space, while remaining visible and, therefore, useful, from a distance.

Despite the challenges arising from the positioning and size of the device, the information and data is conveyed via the disclosed user interfaces in a manner that is readily viewed and otherwise accessible. These scenarios include but are not limited to when the user may be viewing the user interface from a considerable distance, e.g., when a user may prefer to view the user interface without entering a refrigerated enclosure. A readily viewable interface display may also be useful in a scenario in which a user must frequently check a number of thermometers over a long period of time (e.g., a six-hour cooldown period). The challenge to quickly convey the information is heightened when a considerable number of containers are being monitored.

Yet another challenge unique to the food monitoring context involves the manner in which the thermometer is positioned. For the most useful temperature readings, the thermometer may be positioned such that the temperature input or transducer remains centered in the food (e.g., away from container edges). A number of aspects of the disclosed thermometers and monitoring methods are directed to maintaining this positioning, while still facilitating access to the user interface. That is, the thermometer may be configured to maintain the positioning of the transducer while enabling the user interface to be viewed without requiring a user to pick up, raise or otherwise re-position the thermometer.

In accordance with several aspects of the disclosure, the disclosed thermometers and monitoring methods comprehensively provide status information and data despite the multiple stages. In some cases, the user interface may include a plurality of like or similar elements, where each element is associated with a respective temperature stage. For instance, the user interface may include multiple clocks or timers. A respective timer may then be dedicated to each temperature stage. The clocks may convey the times at which cooling stages are completed. In these and other cases, a clock or timer may be triggered when a cooling stage is reached such that the clock provides an indication of the time elapsed since the zone was reached. To this end, each clock may convey the time information as a count-up timer.

Another aspect of the comprehensive presentation of status information by the disclosed thermometers involves maintaining the presentation throughout the procedures. In other words, the status information and other data for a temperature stage or zone remains conveyed, depicted or otherwise available via the user interface after completion of the stage. In this way, a user need not be concerned with conducting status checks during each temperature zone or stage to catch information only temporarily available. This feature may be particularly advantageous in a context in which a large number of food items are being monitored. To this end, a status indicator, the aforementioned clock, or other element of the user interface may be dedicated to conveying information or data for a specific stage or zone. Having dedicated user interface elements for multiple stages in a manner that retains a convenient and compact interface is yet another challenge addressed by the disclosed thermometers and monitoring methods. As described below in connection with a number of exemplary embodiments, the user interface may include indicator lights having colors, blinking rates and other properties to efficiently convey information and data both during and after the completion of a stage. In these and other ways, the disclosed thermometers and monitoring techniques address the challenges involved with, or arising from, the multiple-stage nature of a cooldown procedure.

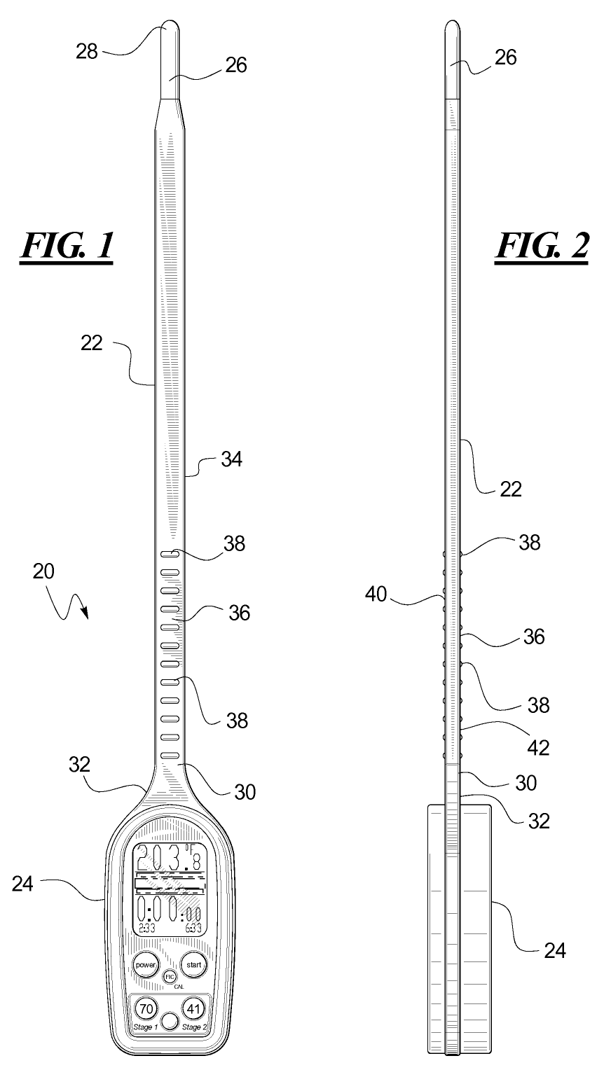

Turning now to the drawing figures, FIG. 1 depicts an exemplary thermometer indicated generally at 20 and having an input probe 22 and a housing 24 for device electronics. The input probe 22 and the housing 24 are cohesively linked and secured to one another such that the thermometer 20 is constructed as a single-piece, portable unit. In this way, the thermometer 20 has an integrated, handheld configuration, thereby simplifying its use as a measurement instrument. A transducer section 26 of the thermometer 20 is located at an end 28 of the input probe 22. The transducer section 26 may include a thermocouple, thermistor, or any other temperature sensing component, as desired. The housing 24 is secured to, and located at, an opposite end 30 of the input probe 22. In this example, a connector 32 links the input probe 22 to the housing 24 to form a cohesive link. The connector 32 may be configured as a tapered sleeve or other covering to protect and smooth the transition from the input probe 22 to the housing 24.

The input probe 22 may be considerably elongated such that the length or distance between the ends 28 and 30 can accommodate the positioning of the transducer section 26 within large food containers. In between the ends 28, 30, the input probe 22 may include a covering 34 that extends a desired length of the input probe 22. The covering 34 may shield temperature-sensitive, interior components (not shown) running from the transducer section 26 to the housing 24. Alternatively or additionally, the covering 34 may protect components carrying electrical signals from the transducer section 26 to the housing 24. To these ends, the covering 34 may be formed from a rubberized or other insulative material. The covering 34 may be formed in a variety of ways, including for instance as an over-mold layer or sleeve. The layer or sleeve may include or present a friction-enhancing or grip-enhancing material on its exterior surface in the interest of engaging a food container, as described below. In some cases, the connector 32 and the covering 34 may form an integrated layer, such as an over-mold layer, to further cohesively link the input probe 22 and the housing 24.

The input probe 22 is flexible to adjust the relative positioning of the components of the thermometer 20. For example, the flexibility of the input probe can be used to direct the transducer section 26 to a desired position within the food to be monitored. The flexibility can also be used to position the housing for convenient user access, which may otherwise be challenging due to the nature or shape of the container in which the food is disposed. In some embodiments, the input probe 22 may be flexed or bent in any direction. In these and other cases, the flexibility of the input probe 22 involves plastic deformation such that the positioning of the transducer section 26 is substantially maintained.

As best shown in FIG. 2, the covering 34 may also include a ribbed section 36 in which a number of ribs 38 project outwardly from the input probe 22. Each of the ribs 38 need not project from the same surface of the input probe 22. Accordingly, the ribs 38 may project in different directions. In this example, some of the ribs 38 project in a first direction from a front surface 40, while others project in an opposite direction from a rear surface 42. In this example, each rib 38 runs transversely across the width of the ribbed section 36 (as shown in FIG. 1) with a semi-circular or rounded cross-section. The ribs 38 may, but need not, run substantially the entire width of the ribbed section 36. Each rib 38 may be formed of the same rubberized or insulative material as the covering 34 and, as such, be integrally formed therewith. Alternative embodiments may include or involve an over-mold arrangement having different materials for the ribs 38 and the covering 34. More generally, the size, shape, positioning, and composition of the ribs 38 may vary considerably as desired. Moreover, these characteristics of the ribs 38, as well as the spacing or distance between adjacent ribs 38, may vary across the section 36.

The housing 34 may be formed as an injection-molded plastic enclosure or shell. The connector 32, the covering 34, and other external components of the thermometer 20 may then be injection over-molded layers. These structural and material details are provided, however, with the understanding that the structural characteristics and materials of the input probe 22, the housing 34, and other components of the thermometer 20 may vary considerably from the example shown.

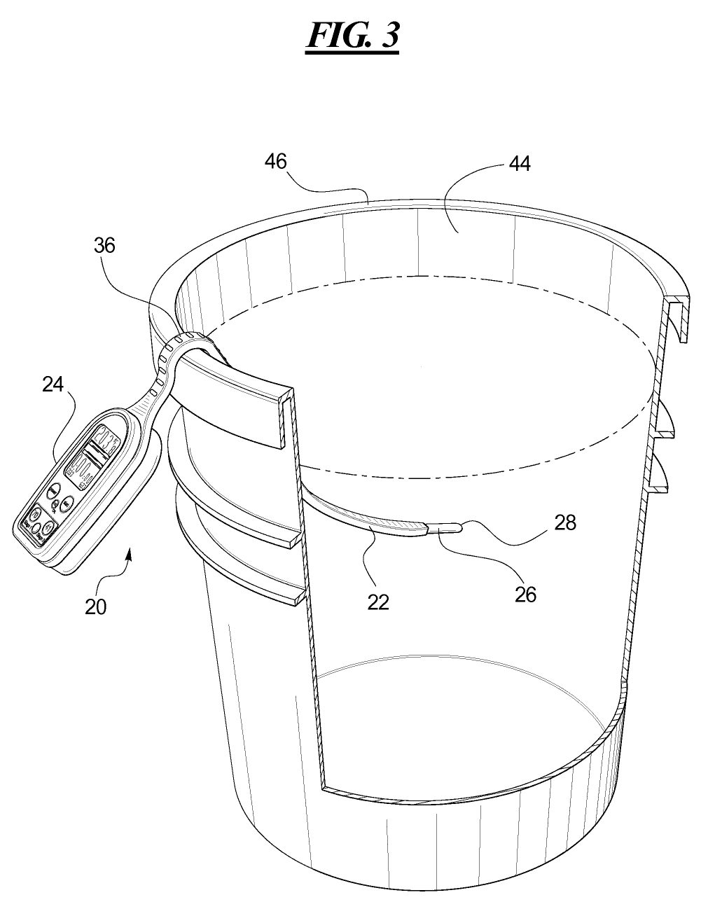

Turning now to FIG. 3, the ribbed section 36 is generally directed to facilitating the engagement of the thermometer 20 and a food container 44. In this example, the input probe 22 is bent to conform to an edge 46 of the container 44. The flexibility of the input probe 22 can accommodate a variety of edge shapes and sizes. In this case, the edge 46 includes three surfaces forming a U-shaped cross-section, each of which is engaged by the ribbed section 36 of the input probe 22. Once bent to engage the edge 46 of the container 44, the ribs 38 (FIG. 2) and the plastic nature of the deformation of the input probe 22 secure the thermometer 20 in the position shown. Specifically, the ribs 38 can help prevent slippage or other displacement along, for instance, the direction(s) in which the input probe 22 extends. The plastic deformation of the ribbed section 36 then helps avoid displacement in other directions. Limiting displacement of the input probe 36 relative to the edge 46 of the container 44 helps to maintain the positioning of the transducer section 26 within the container 44 and prevent unintended disengagement. A central position of the transducer in the container may, for instance, be useful for obtaining accurate temperature measurements.

FIG. 3 also depicts several ways in which the transducer section 26 of the thermometer 20 can be positioned within the container 44 for accurate temperature monitoring. The input probe 22 is bent both to engage the edge 46 of the container 44 and to position the transducer section 26, as desired. In the example shown, the input probe 22 is bent downward from the edge 46 of the container 44 such that the transducer section 26 reaches an appropriate depth or level within the container 44. The input probe 22 is also bent upward at a point closer to the end 28 such that the transducer section 26 is centered within the container 44, or to some other desired position. Such positioning of the transducer section 26 may be advantageous if, for instance, the temperature of an interior portion of the food is more relevant or otherwise useful. The challenge met by the disclosed thermometer involves attaining such positioning while also locating the user housing 24 for convenient user access. In this way, a user can conveniently obtain information and data without interrupting the temperature monitoring or otherwise disturbing the thermometer 20. Indeed, as explained below, these and other aspects of the disclosed thermometer and monitoring methods allow a user to obtain information and data without any contact with, or movement of, the thermometer 20. Moreover, these aspects of the disclosed thermometers can provide such functionality while accommodating a variety of container sizes and shapes.

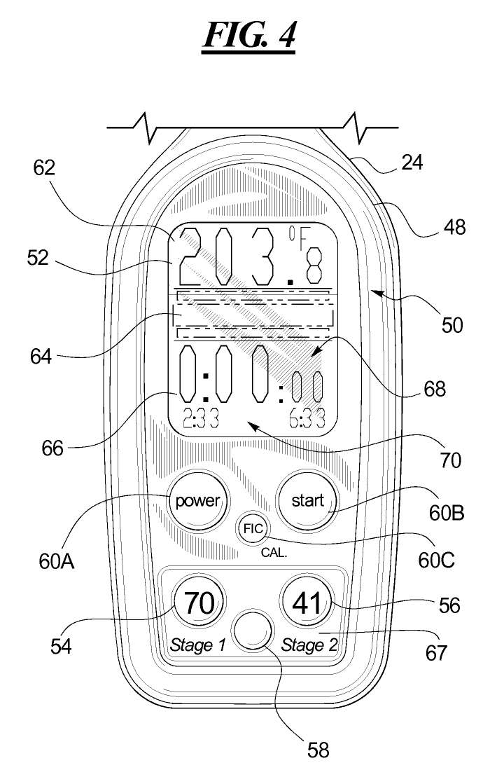

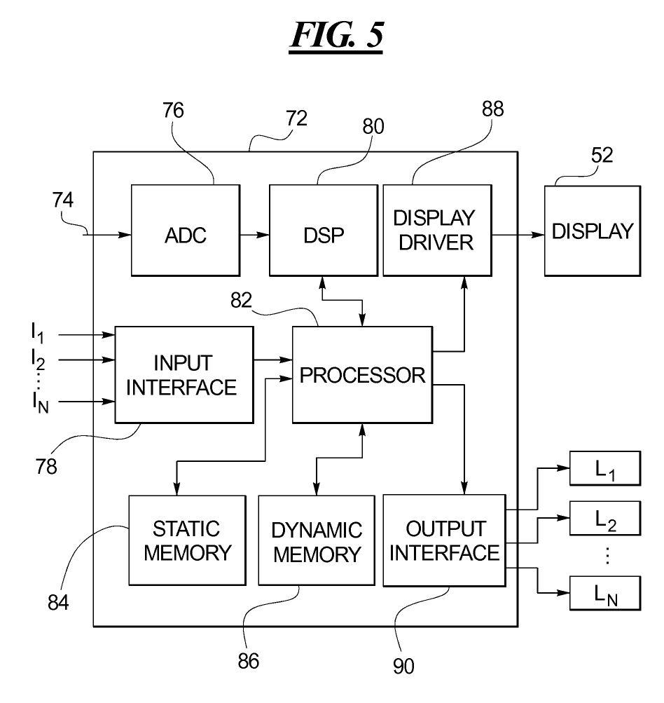

With reference now to FIG. 4, the housing 24 has a front face or side 48 upon which a user interface indicated generally at 50 is disposed. The user interface 50 includes a number of elements directed to obtaining user input or direction, as well as a number of elements directed to providing feedback or other information to a user. The manner in which the user interface 50 obtains user input or provides information may vary considerably. Nonetheless, several aspects of the user interface 50 generally support user input and information displays in an efficient and convenient manner despite the challenges and other circumstances presented by the food temperature monitoring context. For instance, all of the elements of the user interface 50 are presented clearly and completely on the front face 48 of the housing 24 in this example. This positioning allows a user to interact with the thermometer without having to move or relocate the device during a monitoring operation. Alternative embodiments, however, may include one or more user interface elements on other sides, faces, or portions of the housing 24. For example, one or more user input elements that are accessed infrequently (e.g., an ON/OFF button or other switch to initiate a procedure) may be disposed on a side or rear face of the housing 24. More generally, and as described below, the user interface arrangement is directed to comprehensive and convenient interaction with the user.

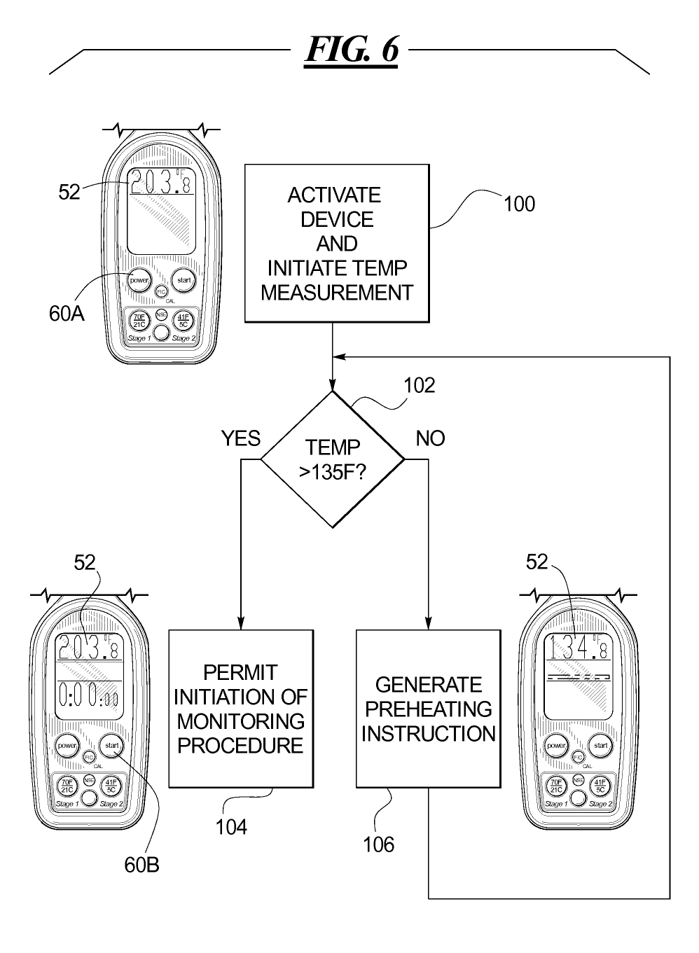

In this exemplary case, the user interface 50 includes an alphanumeric display 52, non-alphanumeric status indicators 54 and 56, a non-alphanumeric compliance indicator 58, and a set of tactile user input selects or buttons 60A-60C. Operational details of these user interface elements are described below in connection with FIGS. 6-9. Generally speaking, however, the alphanumeric display 52 includes a number of panels or areas dedicated to displaying certain information or data, including a panel 62 to provide temperature data, a panel 64 to provide textual instructions and other information, and a panel 66 to provide time information for one or more clocks or timers. In this case, the alphanumeric display 52 includes one or more liquid crystal display (LCD) units, although other display technologies may also be well-suited for use with the disclosed thermometers.

The non-alphanumeric indicators 54, 56, 58 may provide status and compliance information visually via any illumination technology, e.g., back lighting, etc. Each indicator 54, 56, 58 may include or utilize one or more lamps (not shown) or other sources of illumination (e.g., light-emitting diodes, or LEDs). The lamps may be activated and deactivated in a variety of ways to indicate status or, more generally, convey information via a coding or signaling scheme. In one exemplary coding scheme, the lamps are activated and deactivated at varying rates to indicate status. Other coding schemes may involve varying light intensity, light color, combinations of lamps, and the like. In this example, the non-alphanumeric indicators 54, 56, 58 are arranged or grouped in a panel or area 67 located beneath the display 52. The arrangement and positioning of these visual indicators may vary considerably from the example shown.

Taken together, the alphanumeric display 52 and the non-alphanumeric indicators 54, 56, 58 are generally directed to providing information regarding a process or procedure in which temperature varies over time in accordance with a set of guidelines. The guidelines establish a timed schedule of temperature zones or levels to be reached during the course of the procedure. In some cases, the elements of the user interface 50 are generally configured in accordance with the guidelines. For instance, the number of user interface elements, the element layout, and functionality (e.g., purpose) may be preconfigured, or preset, to accommodate the guidelines. As a result, some of the user interface elements (or aspects thereof) may be dedicated to a certain guideline or number of guidelines.

More generally, the user interface elements convey the extent to which the measured temperature reaches the desired temperature zones or levels and otherwise complies with the guidelines. In accordance with one aspect of the disclosure, the user interface does so in a manner that does not force the user to constantly monitor the user interface 50 throughout the length of the procedure. In some cases, the procedure may last a considerable amount of time, e.g., six hours. These elements of the user interface 50 allow the user to obtain comprehensive status and compliance information at any point during the procedure, even if a particular temperature zone or level has been passed. That is, the user interface 50 is configured to provide compliance information for both previous and current stages. The user may then access the information after the completion of the last stage of the procedure, i.e., after all of the temperature zones or levels have been passed.

These aspects of the disclosure are illustrated and described herein via a description of the operation of the user interface 50 in connection with an exemplar temperature monitoring procedure involving two stages or temperature zones. In this case, the procedure generally involves safely cooling food down from a cooking temperature through the two stages or zones. Thus, levels of decreasing temperatures define the zones or stages, namely 140 F, 70 F and 41 F. The temperature zones correspond with the stages of the cooldown procedure promoted by the guidelines described above, specifically that the food should be cooled from 140 F to 70 F within two hours, and from 140 F to 41 F within six hours.

In the exemplary case shown, portions of the user interface 50 are dedicated to, or otherwise associated with, respective stages or temperature zones of the temperature monitoring procedure. For example, the status indicator 54 is dedicated to conveying information regarding a first stage or temperature zone from 140 F to 70 F. The status indicator 56 is dedicated to conveying information regarding a second stage or temperature zone from 70 F to 41 F. The alphanumeric display 52 may also have panels or portions dedicated to, or associated with, the first and second stages. For example, the panel 64 includes textual instructions for the first and second stages that may be selectively bolded or otherwise highlighted in accordance with the current stage. The panel 66 may have a primary clock area indicated generally at 68 for displaying the current elapsed time, while elapsed times associated with the first and second stages may be displayed in a secondary clock area indicated generally at 70. In the example shown in FIG. 4, the secondary clock area 70 has a clock or timer indicating the time elapsed (2:33) to complete the first stage, and another clock or timer indicating the time elapsed (6:33) to complete the second stage. The primary clock area 68 reads 0:00:00 to indicate that both the first and second stages have been completed.

Not all of the elements of the user interface 50 need to be dedicated to, or associated with, a single stage or zone. For instance, a single indicator may convey information or data in a composite or compiled fashion. In the example shown, the non-alphanumeric indicator 58 may convey information regarding the overall degree with which the guidelines have been complied. To this end, the appearance of the indicator 58 may change in a number of ways (e.g., intensity, color, blink rate, etc.). For example, the activation and deactivation (i.e., blink rate) of the indicator 58 may be modulated to reflect a degree of compliance. The blink rate may range from a slow blink rate to one or more faster blink rates or continuous activation. Alternatively or additionally, the user interface 50 may include elements that toggle between respective stages or zones. More specifically, a portion of the user interface 50 may convey information or data for multiple stages or zones by alternating between the stages or zones. For example, the panel 66 of the alphanumeric display 52 may display multiple clocks or timers in a single area (e.g., the primary clock area 68) by switching between the display of the current elapsed time, the first stage elapsed time, and the second stage elapsed time. An option to have the display 52 periodically progress through the zones may then be provided. To assist the user in determining which elapsed time is displayed, another portion of the user interface 50 may be dedicated to identifying the current stage for which information or data is being displayed. For example, the textual information in the panel 64 for the current stage may be highlighted or otherwise marked to indicate the current stage for which information or data is being displayed. In an alternative embodiment, an LED or other indicator may be activated to indicate the current stage or zone.

Generally speaking, the elements of the user interface 50 provide the status or compliance information and data in a redundant fashion to facilitate user-friendly and convenient access thereto. The redundancy provides a user with a mechanism for, on the one hand, quickly ascertaining status information at times and, at other times, obtaining more detailed status information when a closer inspection of the user interface 50 is practicable. In the example shown, the non-alphanumeric indicators are well-equipped to provide quick status updates, while the alphanumeric elements of the display can readily provide more detailed information. For example, general compliance information with the first and second stage guidelines is displayed via the status indicators 54 and 56, as well as the compliance indicator 58. However, the time information displayed in the secondary clock area 70 also indicates whether the first and second stage guidelines have been met via comparison with the scheduled times (e.g. two hours and six hours). Thus, in this example, the time information in the secondary clock area 70 provides further, more detailed information, such as exactly how much time elapsed before completion of the stage. Such information may be useful in distinguishing between situations in which the guideline was missed by markedly different periods of time (e.g., less than one second versus 10-20 minutes). In contrast, the visual indicators 54, 56, and 58 provide a quick and convenient way to determine the results of the temperature monitoring procedure, even when a user is not in close proximity to the user interface 50. Other elements of user interface 50, such as the textual information in the panel 64, may then provide more detailed information when the user can more closely inspect the user interface 50.

FIG. 5 is a block diagram depicting a number of components of the thermometer 20 that support the user interface and other functionality described above. As a general matter, the components are disposed within the housing 24 (FIG. 1) and configured to control and direct the operation of the thermometer 20. In this example, a digital controller 72 is configured to control the alphanumeric display 52 and any number of lamps or other non-alphanumeric visual indicators L₁, L₂, . . . L_{N}, such as the indicators 54, 56, 58 (FIG. 4). The controller 72 is generally responsive to an analog temperature signal 74 and any number of input control signals I₁, I₂ . . . I_{N}. The analog temperature signal 74 may be generated by a temperature sensor (not shown) in the transducer section 26 (FIG. 1) and carried the length of the input probe 22 via wires or other conductive lines (not shown) until reaching the controller 72. The analog temperature signal 74 may be processed by an analog-to-digital converter 76 dedicated to the temperature data or configured for processing one or more additional input signals. The input control signals I₁, I₂, . . . I_{N} may be generated via user actuation of corresponding user interface elements (e.g., the user selects 60A, 60B). An input interface 78 may couple the lines carrying the input control signals to the remainder of the controller 72, converting and otherwise conditioning the signals for subsequent digital processing. The information and data provided by the analog-to-digital converter 76 and the input interface 78 may be delivered to a digital signal processor (DSP) 80 for further processing. In the example shown, the DSP 80 receives the temperature data, but may additionally receive one or more of the input control signals.

The DSP 80 may perform or implement a number of computations or routines to present the temperature data in a desired form. For example, computations or routines may be directed to removing noise captured or generated by the analog-to-digital converter 76. Furthermore, computations or routines may be directed to processing a desired number of samples of temperature data into a more convenient representation of the measured temperature. For instance, the routines may include or incorporate averaging operations and other statistical techniques. A number of commercially available digital signal processor circuits or chips are suitable for use as the DSP 80. The chip(s) providing DSP functionality may also provide a variety of upstream signal conditioning and other operations. In fact, the analog-to-digital converter 76 and the DSP 80 may be integrated in a single chip or chipset in some cases.

In this exemplary case, the digital controller 72 includes a processor 82 to coordinate and manage the functions implemented by other components of the controller 72. To these ends, the processor 82 implements one or more control routines, the instructions and other details of which may be stored in a static memory 84. The static memory 84 may be physically integrated with the processor 82 to any desired extent. More generally, the instructions and other details regarding the routine(s) configure the processor 82, which may be a general-purpose processor, such as a microprocessor or microcontroller. A number of commercially available microprocessor and microcontroller circuits or chips are suitable for use as the processor 82. In some cases, the DSP 80 and the processor 82 may be physically integrated into a single chip or chipset. In other cases, the processor 82 may implement the functions and other procedures described above or associated with the DSP 80. Similarly, the DSP 80 may be configured to implement any one or more of the functions and other procedures described above or associated with the processor 82.

During implementation of the routines, temperature and other data generated or used by the processor 82 is stored in a dynamic memory 86. The dynamic memory 86 may also be in communication with any of the other elements of the controller 72, such as the input interface 78, the DSP 80, etc. The dynamic memory 86 may be physically integrated with the processor 82 or the DSP 80 to any desired extent. In some cases, the dynamic memory 86 includes a flash memory chip. A number of commercially available standalone memory chips are suitable for use as the dynamic memory 86.

The implementation of the routines by the processor 82 directs a display driver 88 and an output interface 90 to control the alphanumeric display 52 and set of lamps L₁, L₂ . . . L_{N} for any number of visual indicators, respectively. To these ends, data processed or generated by the processor 82 is sent along with instructions to the driver 88 and the interface 90. The driver 88 and the interface 90 may be configured to respond to the instructions in a manner that converts the data into control signals appropriate for the alphanumeric display 52 and the set of lamps L₁, L₂ . . . L_{N}. Any one or more functions, features, or capabilities of the display driver 88 and the output interface 90 may be integrated with, or handled by, the processor 82 to any desired extent.

Communications between the above-described components of the controller 72 may involve lines or other connections supporting communications in the directions shown in FIG. 5. Alternatively or additionally, the communications may be supported by a data bus (not shown), as desired. The lines, bus, or other connections may be disposed on one or more circuit boards (not shown) upon which any one or more of the above-described components of the controller 72 are mounted or disposed.

The processor 82 provides a timing or clock function in accordance with a dedicated routine, or as part of another routine. The clock function generally tracks or counts the time elapsed from a trigger point. The processor 82 may be configured with a separate routine to determine the trigger point. In some cases, the trigger point may be user initiated. In the example based on the above-described cooldown guidelines, the trigger point is when the measured temperature reaches 140 F.

The processor 82 implements one or more routines directed to a monitoring procedure based, in part, on the elapsed time tracked by the clock function. The monitoring procedure generally involves tracking the measured temperature and elapsed time in view of the time and temperature guidelines established for the food being monitored. Instructions specifying the details of the monitoring procedure and the data underlying the time and temperature guidelines may be stored in the static memory 84 and, in some cases, may be additionally or alternatively stored in the dynamic memory 86. For instance, some embodiments may involve or include user programming of the controller 72, in which the time and temperature guidelines may be customized or specified as desired via the user interface 50.

Further details regarding the implementation of an exemplary monitoring procedure by the controller 72 are now set forth in connection with FIGS. 6-9, each of which depicts the state of the user interface 50 at various points in the procedure.

Turning now to FIG. 6, the monitoring procedure begins in a block 100 with the actuation of the user select 60A, which results in the activation of the thermometer 20. Specifically, the user select 60A may present a POWER ON/OFF toggle option to initiate a startup phase or stage of the procedure. Upon activation of the thermometer 20, the alphanumeric display 52 may display the current measured temperature. In some cases, instructions may be provided via the alphanumeric display 52 as to how to move forward with the procedure. In this exemplary case, control then passes to a decision block 102 in which the processor 82 determines whether the current measured temperature exceeds 135 F. If yes, a user can then actuate the user select 60B (“START”) in a block 104 to initiate the monitoring procedure. To this end, the user select 60B may be illuminated either continuously or intermittently to indicate the availability of the option to initiate the procedure. The procedure eventually begins with the alphanumeric display 52 being directed to convey that the “timer starts at 135 F”. A primary clock is shown in the alphanumeric display 52 to indicate the elapsed time. Because the current measured temperature remains above the trigger threshold temperature of 135 F, the clock has yet to begin counting up from a time of 0:00:00.

If the current measured temperature does not exceed 135 F upon actuation of the user select 60A, then the guidelines specify that it is not yet appropriate to begin the cooldown procedure. Control accordingly passes to a block 106 in which the alphanumeric display 52 is directed to provide the instruction “preheat food to 165 F”. In this case, the thermometer 20 is attempting to ensure that the food reaches a temperature suitable for killing pathogens before initiation of the cooldown procedure. To this end, the guidelines and the alphanumeric display 52 specify that the food should remain heated at a temperature of 165 F for 15 seconds. Control may eventually return to repeat the implementation of the decision block 102 as shown, either before, after or during the preheating of the food to a temperature of 165 F. Alternatively or additionally, the processor 82 may be configured to detect whether the food has remained at a temperature of 165 F for at least 15 seconds (or some other desired temperature and duration) before passing control to the block 104.

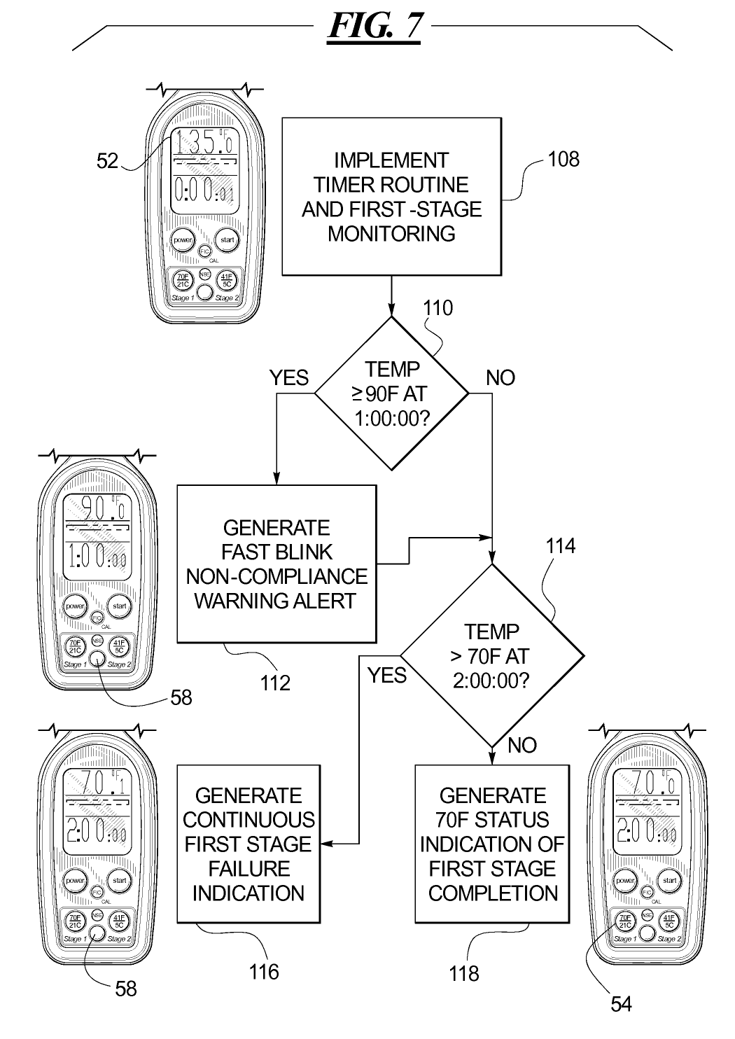

FIG. 7 depicts a number of steps taken during implementation of the monitoring procedure during the first of two stages. The first stage corresponds with the temperature zone beginning at a temperature of 135 F and ending at a temperature of 70 F. Thus, the first stage begins once the measured temperature reaches a trigger temperature of 135 F after cooling down from a higher cooking temperature. At that trigger temperature, the processor 82 starts a timer routine in a block 108 to support the primary clock in the alphanumeric display 52. The processor 82 also directs the alphanumeric display 52 to depict a textual indication that the first stage of monitoring has begun. The textual indication also specifies that the food is to be cooled to a temperature of 70 F within two hours.

At the one hour mark, the processor 82 determines in a decision block 110 whether the current temperature is at or above 90 F. If yes, control passes to a block 112 in which the processor 82 generates a warning alert to indicate possible noncompliance. In this case, the warning alert is provided as a fast blinking of the compliance indicator 58. The color of the compliance indicator 58 may also be indicative of the degree (or lack) of compliance. For example, the compliance indicator 58 may have a red color associated with a warning alert or other negative status or result. Eventually, or if the measured temperature at the one hour mark is less than 90 F, control passes to another decision block 114 in which the status at the end of the first stage is determined. Specifically, the processor 82 determines whether the temperature measured past the two hour mark is greater than 70 F. If yes, then control passes to a block 116 in which the processor 82 generates a failure indication for the first stage by directing the compliance indicator 58 to be continuously activated (e.g., a non-blinking, red alert). If not, then control passes to a block 118 in which the processor 82 generates a status indication of the successful completion of the first stage via the activation of the status indicator 54.

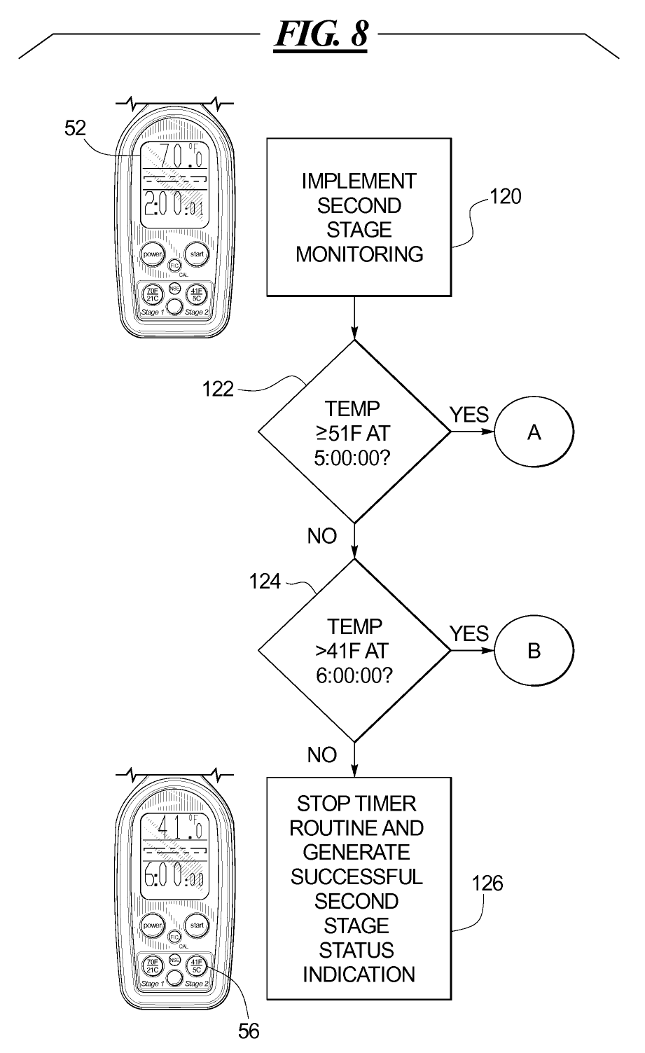

FIG. 8 depicts a number of monitoring steps to be implemented by the processor 82 during the second stage of the procedure. As a general matter, the steps depicted in FIG. 8 assume that the second stage has followed a successful completion of the first stage. At the two-hour mark, second stage monitoring is initiated by the processor 82 in a block 120, which continues the implementation of the timer routine to track the elapsed time. In this example, the timer routine implemented by the processor 82 tracks the total elapsed time and, in so doing, supports the continued depiction of the total elapsed time via the primary clock in the alphanumeric display 52. The timer routine may alternatively or additionally track the elapsed time from completion of the first stage. Next, a processor 82 determines in a decision block 122 whether the current temperature at the five-hour mark is equal to or greater than 51F. If not, control passes to another decision block 124 in which the processor 82 determines whether the current temperature at the six-hour mark is greater than 41 F. If not, then control passes to a block 126 in which the processor 82 stops the timer routine and generates an indication of the successful status and completion of the second stage via the status indicator 56.

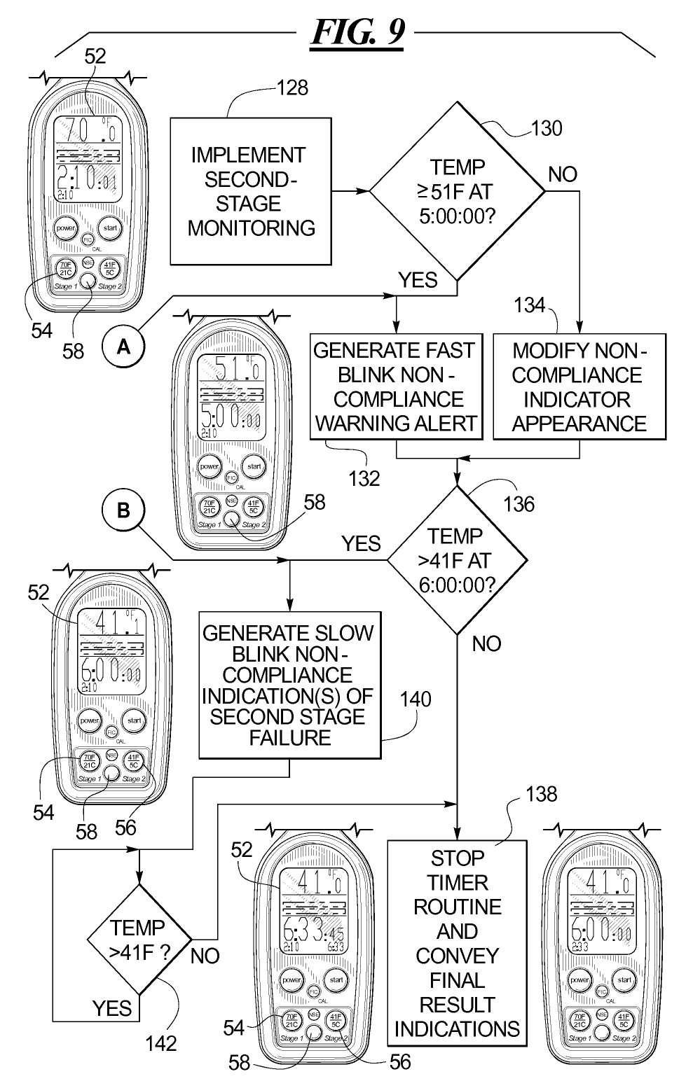

The processor 82 enters the flow of the second stage of the monitoring routine set forth in FIG. 9 in the event that the current temperature fails to meet the five-hour and six-hour mark thresholds specified above. The points at which control passes from the flows shown in FIGS. 8 and 9 are specified as transitions A and B in both figures. Specifically, if the current temperature is equal to or greater than 51 F at the five-hour mark, then control passes to the flow of FIG. 9 via the transition A. If the current temperature is greater than 41 F at the six-hour mark, then control passes to the flow of FIG. 9 via the transition B.

With reference now to FIG. 9, the flow begins with a block 128 as the current temperature eventually reaches the temperature zone or threshold of the second stage (i.e., 70 F). In this case, the second stage is reached at an elapsed time of two hours, 10 minutes, and one second. The processor 82 therefore begins the implementation of the second stage at that time, continuing the timer routine to support the primary clock shown in the alphanumeric display 52. Because the first stage was not completed successfully, the processor 82 directs the status indicator 54 to blink at a slow rate. The slow blink rate may be understood to correspond with an indication of failure and the respective stage. At this time, the failure in the first stage may also be indicated via continuous activation of the compliance indicator 58. The compliance indicator 58 may remain continuously activated until the time elapsed reaches the next time or temperature threshold, at which point the indicator 58 begins to provide information regarding that threshold. The processor 82 also directs the display 52 to depict the time elapsed during the first stage in a secondary clock, as described above.

The flow continues with the processor 82 implementing a decision block 130 in connection with the same intermediate temperature condition described above in connection with the five-hour mark. Specifically, if the temperature is at or above 51 F, then control passes to a block 132 in which the processor 82 directs the compliance indicator 58 to blink at a fast rate to indicate a warning alert. In this respect, the warning alert is similar to the alert that may be issued at the one-hour mark, another intermediate status check in the midst of a stage or temperature zone. Alternatively, one may think of the intermediate elapsed times at the one- and five-hour marks as demarcating separate stages or temperature zones. If the temperature is below 51 F, then control passes to a block 134 in which the processor 82 modifies the appearance of the non-compliance indicator 58, which had been continuously activated since the failure to meet the requirements of the first stage. In one exemplary case, the processor 82 directs the indicator 58 to a slow-blink mode. Another exemplary case involves deactivating the indicator 58 until the end of the second stage. In either case, the appearance of the indicator 58 is modified to reflect the degree of compliance for the current stage. Despite this switch to the second stage, the first stage results may still be conveyed via the slow-blink mode of the indicator 54. which is dedicated to, or associated with, the first stage.

After passing the five-hour mark, control passes to a decision block 136 in which, as with the block 124 (FIG. 8), the processor 82 determines whether the current temperature is above 41 F at the six-hour mark. If not, then the timer routine is stopped in a block 138, and the processor 82 further directs the user interface to convey one or more indications of the final results of the monitoring procedure. In this example, the first stage requirements were not met, but the second stage requirements were met. Accordingly, the status indicator 54 remains in the slow-blink mode, the status indicator 56 is continuously activated or otherwise controlled to indicate successful stage completion, and the non-compliance indicator 58 is activated in a manner to indicate partial non-compliance (e.g., failure in one or more, but not all, of the stages). For example, the non-compliance indicator 58 may be activated in a slow-blink mode, which, when depicted along side the indicators 54 and 56, will convey that the failure was in the first rather than the second stage.

When the decision block 136 finds non-compliance in the second stage, then control passes to a block 140 in which the processor 82 directs the non-compliance indicator 58 to convey current non-compliance via, for instance, continuous activation. The processor 82 may also direct the status indicator 56 to convey failure in the second stage via activation at a slow blink rate. At this point, the timer routine implemented by the processor 82 continues to track the elapsed time beyond the six-hour threshold, and the processor 82 continues to direct the alphanumeric display 52 to convey the elapsed time via the primary clock. A decision block 142 determines when the current temperature finally reaches 41 F, eventually passing control to the block 138 to stop the timer and depict the final result indications. In this case, the alphanumeric display 52 is directed to generate a secondary clock to depict the time elapsed to complete the second stage (6:33). The status indicators 54, 56 and the non-compliance indicator 58 are directed to convey that neither stage was met. In this example, the non-compliance indicator 58 remains continuously activated, and the status indicators 54, 56 are activated at a slow blink rate.

Throughout the implementation of the above-described monitoring procedure, the alphanumeric display 52 may display textual information to convey instructions or information that reflect the status of the procedure, including the degree to which the guidelines have been met. Such information and instructions may be repetitive of the information conveyed via the non-alphanumeric status indicators, clocks, and other aspects or elements of the user interface 50. For instance, the alphanumeric display 52 may be directed to convey during the implementation of the first stage of monitoring (FIG. 7) the following information: “Stage One—2 Hrs to 70 F/21 C.” As part of the implementation of the block 116 (FIG. 7), the failure to meet the requirements of the first stage may also include the processor 82 directing the display 52 to convey the instruction “Reheat food to 165 F/74 C.” This instruction may continue to be displayed throughout the remainder of the procedure, including those cases where the requirements of subsequent stages are met. Once the second stage begins, the alphanumeric display 52 may be directed to remove the information regarding the first stage, conveying instead the following information: “Stage Two—4 Hrs to 41 F/5 C,” as shown in FIGS. 8 and 9.

The non-alphanumeric status indicators 54, 56 and 58 may have color coding that provides an easy way to gain status and other information from the user interface 50 from a considerable distance. For instance, the activation of the status indicators 54 and 56 with yellow and green sources of illumination, respectively (or filters or other techniques to transmit the respective color), provides an easy way to distinguish them. Similarly, the non-compliance indicator 58 may be activated with a red illumination source (or filter or other technique to transmit the color red). Such color coding may be combined with the activation of the indicators 54, 56, and 58 at selected blinking rates to further facilitate long-range use. In one example, the blink rates are controlled via the display driver 88 (FIG. 5), while the color coding is achieved via colored lens, layer, or film. As shown in the examples depicted in the drawing figures, the status indicators may also have alphanumeric information printed thereon or otherwise integrated therewith (e.g., “70 F”, “Stage 1”, etc.). These textual additions may, for example, provide an initial or backup reminder of the stage or purpose for the indicator.

The foregoing times, temperature thresholds, stages and temperature zones are provided with the understanding that they are merely exemplary in nature. Practice of the disclosed devices and methods is well suited for any number of stages or zones at a variety of time and temperature thresholds.

More generally, the configuration of user interface 50 and the processor 82 facilitate the monitoring of the food temperature procedure because a number of aspects and elements of the user interface 50 are maintained during operation. Because the procedure involves multiple stages, maintaining user interface elements throughout the procedure allows the user to quickly ascertain current status as well as past results. The above-described aspects and elements of the user interface 50 are therefore directed to providing both past and present indications of status and compliance. In this way, the lack of compliance in one stage is not overshadowed by subsequent compliance in a later stage. The degree of non-compliance in a specific stage (e.g., 1-2 seconds or 10-20 minutes) can be ascertained well after completion of the stage in question, as well as any number of subsequent stages. Moreover, the information is conveyed via the user interface 50 in a manner that avoids having to consult printouts and other lengthy depictions of data. Rather, the information is conveyed via the user interface 50 in a manner that facilitates a quick and efficient check on status and compliance.

The depiction of past status and results in the foregoing examples generally involves the implementation of the second stage of temperature monitoring. In the block 132, for instance, the processor 82 generates a warning alert in connection with the five-hour mark status check, but also directs the status indicator 54 to continue to blink, despite its association with the first stage. Indeed, the status indicator 54 remains blinking throughout the second stage following a failure to comply with the requirements of the first stage. The blinking of the status indicator 54 is to be contrasted with the continuous activation that results from successful completion of the first stage, as described in connection with the block 118 (FIG. 7).

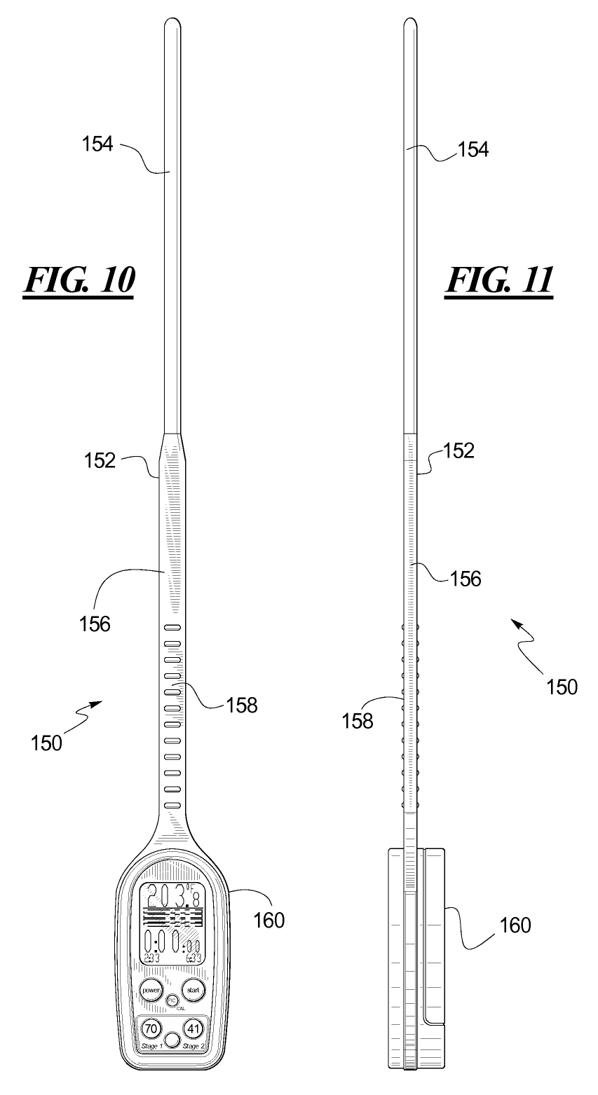

Turning now to FIGS. 10 and 11, a thermometer indicated generally at 150 has an input probe 152 with an extended transducer section 154 to increase contact with the food being monitored. For example, the transducer section 154 may expose about half of the length of the input probe 152 to the food for temperature measurement. The other half of the length of the input probe 152 then has a cover 156 similar to the rubberized or other insulative cover, sleeve, or other layer, described in connection with the embodiment shown in FIGS. 1 and 2. Indeed, the cover 156 may similarly include a ribbed section 158, as well as a similar connection to an electronics housing 160, each of which facilitate the positioning of the thermometer 150 via plastic deformation relative to a food container (not shown). The thermometer 150 may be configured to provide one or more aspects of the above-described user interface functionality and features when in operation.

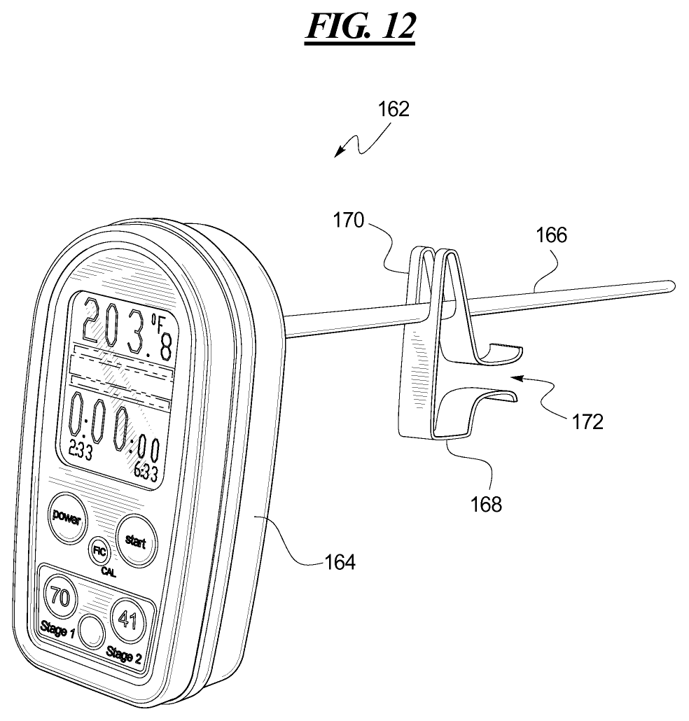

FIG. 12 depicts another exemplary thermometer 162 configured to provide one or more aspects of the above-described user interface functionality. To that end, the thermometer 162 includes an electronics housing 164, an input probe 166, and an attachment clip 168. In this case, the thermometer 162 is generally configured to engage a food container (not shown) via the attachment clip 168 rather than plastic deformation of the input probe 166. To this end, the attachment clip 168 is configured to slidably engage the input probe 166 via a notch 170, and to securely engage an edge of the food container after resilient deflection of a clasp or hook indicated generally at 172. The input probe 166 may be rigid or flexible, as desired.

The user interface 50 need not be limited to visual and tactile interface elements. For example, the user interface 50 may include one or more audio input/output elements (not shown), such as a speaker or a microphone. In other cases, the visual and tactile interface elements may be combined. For example, an area of the user interface 50 providing a visual indicator may also be responsive to tactile input for a specified function. In one case, the START function may be provided by depressing a button located in an area that provides status information for the first stage in the temperature procedure. Similarly, two buttons associated with providing status information for the first and second stages in the procedure may be depressed to implement a POWER ON function. Still further, the display 52 may include a touch-sensitive portion or constitute a touchscreen.

Although certain thermometers and monitoring methods have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A thermometer to monitor food in accordance with a monitoring procedure having multiple stages, the thermometer comprising:
a measurement input probe to contact the food to capture temperature information;
a housing coupled to the measurement input probe and having a user interface comprising a display and a plurality of visual indicators, each visual indicator having a modifiable appearance to convey status information for a respective stage of the multiple stages of the monitoring procedure; and,
a controller disposed in the housing and configured to implement a routine in accordance with the monitoring procedure and in response to the temperature information, the routine comprising a timer routine to count elapsed time during the monitoring procedure;
wherein the routine is configured to cause the controller to direct the display to convey the temperature information and to indicate the elapsed time, and to direct each visual indicator of the plurality of visual indicators to convey the status information in accordance with the temperature information and the elapsed time.

2. The thermometer of claim 1, wherein the routine is further configured to cause the controller to direct the display to indicate the elapsed time via multiple clocks, a respective clock being dedicated to each stage of the multiple stages of the monitoring procedure.

3. The thermometer of claim 1, wherein the routine is configured to cause the controller to direct the display to continue to indicate the elapsed time taken for completion of a stage after a subsequent stage of the multiple stages has begun.

4. The thermometer of claim 1, wherein the routine is configured to cause the controller to direct the visual indicators to concurrently convey information regarding the time elapsed for the completion of the respective stages of the monitoring procedure.

5. The thermometer of claim 1, wherein the measurement input probe has an elongated flexible section configured to position a transducer end of the measurement input probe in contact with the food.

6. The thermometer of claim 5, wherein the elongated section is plastically deformable.

7. The thermometer of claim 1, wherein each visual indicator is configured to illuminate a blinking light at a rate indicative of the status information during completion of the respective stage.

8. The thermometer of claim 1, wherein each visual indicator is configured to illuminate a continuous light upon completion of the respective stage.

9. The thermometer of claim 1, wherein each visual indicator is configured to illuminate a light element in a color indicative of the status information.

10. The thermometer of claim 1, wherein the display further comprises a composite visual indicator dedicated to conveying a degree to which the temperature information is indicative of compliance with the multiple stages of the monitoring procedure collectively.

11. The thermometer of claim 1, wherein each visual indicator is configured to provide a non-alphanumeric alert.

12. The thermometer of claim 1, wherein the user interface is configured such that each visual indicator is separate from the display.

13. The thermometer of claim 1, wherein the housing is cohesively coupled to measurement input probe.

14. The thermometer of claim 1, wherein the status information may be indicative of an intermediate warning of progress toward completion of one of the multiple stages of the monitoring procedure.

15. The thermometer of claim 1, wherein the routine is configured to cause the controller to direct the display to indicate the elapsed time via a count-up timer.

16. A thermometer to monitor food in accordance with a monitoring procedure having multiple stages, the thermometer comprising:
a measurement input probe to contact the food to capture temperature information;
a housing coupled to the measurement input probe and having a user interface comprising an alphanumeric display and a plurality of non-alphanumeric visual indicators, each non-alphanumeric visual indicator having a modifiable appearance to convey status information for the monitoring procedure; and,
a controller disposed in the housing, configured to implement a routine in accordance with the monitoring procedure, and coupled to the measurement input probe to receive the temperature information, the routine comprising a timer routine to count elapsed time during the monitoring procedure;
wherein implementation of the routine by the controller directs the alphanumeric display to convey the temperature information and the elapsed time, and directs the plurality of non-alphanumeric visual indicators to convey the status information in accordance with the temperature information and the elapsed time.

17. The thermometer of claim 16, wherein each visual indicator of the plurality of non-alphanumeric visual indicators is dedicated to a respective stage of the multiple stages.

18. The thermometer of claim 16, wherein the routine is further configured to cause the controller to direct the display to indicate the elapsed time via multiple clocks, a respective clock being dedicated to each stage of the multiple stages of the monitoring procedure.

19. The thermometer of claim 16, wherein each visual indicator of the plurality of non-alphanumeric visual indicators is configured to illuminate a blinking light at a rate indicative of the status information.

20. The thermometer of claim 16, wherein each visual indicator of the plurality of non-alphanumeric visual indicators is configured to illuminate a light element in a color indicative of the status information.
